(19) United States
(12) Patent Application Publication
(10) Pub. No.: US 2006/0120647 A1
(43) Pub. Date: Jun. 8, 2006

(54) Flexible bearing seal

(76) Inventor: Thomas E. Rogus, Stephen, MN (US)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 11/335,942

(22) Filed: Jan. 20, 2006

Related U.S. Application Data
(62) Division of application No. 10/884,248, filed on Jun. 30, 2004.

(51) Int. Cl. F16C 33/76

(52) U.S. Cl. 384/477

(57) ABSTRACT

A bearing seal to protect bearings is formed from polyurethane and includes a raised free edge which contacts the inner race to thereby constantly keep the seal with minimal wear to the race or the seal.

### CROSS-REFERENCE TO RELATED APPLICATIONS

None.

### STATEMENT REGARDING FEDERALLY SPONSORED RESEARCH OR DEVELOPMENT

Not Applicable.

### BACKGROUND OF THE INVENTION

This invention relates to bearings and more particularly to seals to protect the bearings. Bearing assemblies often require a seal to maintain lubricant within the bearing assembly and to prevent dirt and moisture from getting to the bearing assembly. Most prior art seals have a contact point on a shaft which goes through the inner race of a bearing. This shaft usually needs to be ground for increased wearability. Previous designs such as a Nilos ring use a metal shield over a seal member which causes metal to metal wear. Rotation of the race and constant pressure of the seal to the race causes damage to both the race and the seal.

The art described in this section is not intended to constitute an admission that any patent, publication or other information referred to herein is “prior art” with respect to this invention, unless specifically designated as such. In addition, this section should not be construed to mean that a search has been made or that no other pertinent information as defined in 37 C.F.R. § 1.56(a) exists.

### BRIEF SUMMARY OF THE INVENTION

The invention provides a flexible bearing seal that is formed from a flexible material with memory such that it will return to its original position after being loaded into place. The bearing seal is pre-loaded into position and has a free edge which is constantly urged toward the bearing race to keep constant contact with the race. The flexible material used in the flexible bearing seal applies pressure on the seal point which does not appreciably wear the bearing race. The material also has a very low drag on the bearing and repels foreign materials.

The flexible bearing seal of the invention has a fixed end which is kept captive relative to the bearing assembly outer race and a free end with a raised edge that rides against the inner bearing race under constant pressure to keep the bearing sealed. Preferably, the bearing seal is formed from polyurethane such as the polyurethanes marketed under the brand name Pentathane™ by Molded Dimensions, Inc. of Port Washington, Wis. Such urethanes are high load bearing, have abrasion resistance, have a low coefficient of friction, have good resistance to gas, oil, alkali and chemical attack and may be quite flexible while being quite hard. Suitable polyurethanes are disclosed in U.S. Pat. No. 4,410,387 to Molded Dimensions, Inc., the disclosure of which is incorporated herein by reference.

### BRIEF DESCRIPTION OF THE DRAWINGS

A detailed description of the inventive seal which is used to keep foreign materials from contacting the seal area of ball and roller bearings eliminating seal contact with the shaft is hereafter described with specific reference being made to the drawings in which:

FIG. 1 is a cross-sectional view of the flexible bearing seal of the invention protecting a bearing; and

FIG. 2 is a cross-sectional view of the flexible bearing seal of the invention protecting a Timken-style bearing.

### DETAILED DESCRIPTION OF THE INVENTION

While this invention may be embodied in many different forms, there are shown in the drawings and described in detail herein specific preferred embodiments of the invention. The present disclosure is an exemplification of the principles of the invention and is not intended to limit the invention to the particular embodiments illustrated.

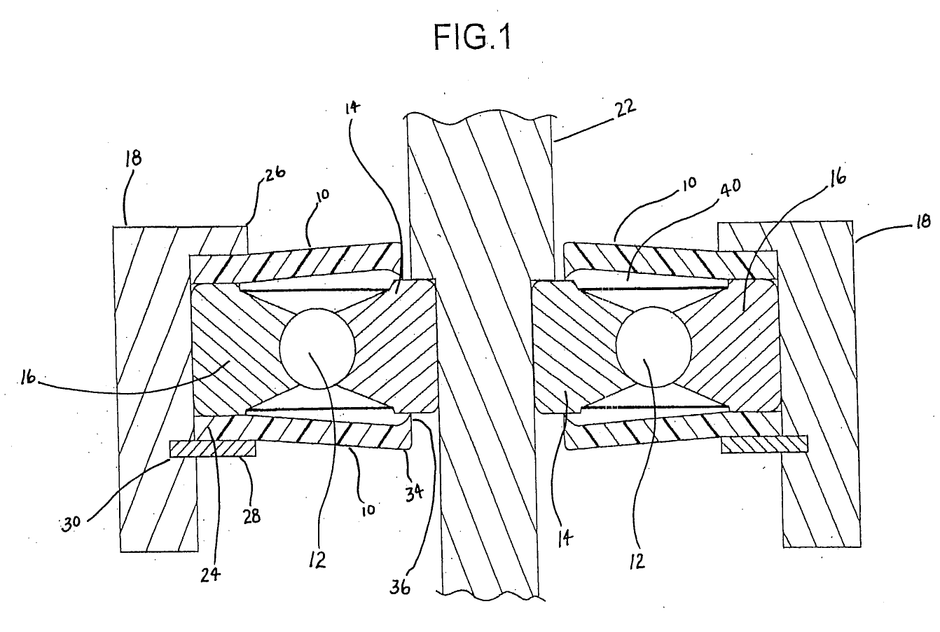

FIG. 1 shows the inventive flexible bearing seal 10 of the invention in connection with a bearing assembly that includes ball bearings 12 and inner and outer bearing races 14 and 16. The housing 18 may either be stationary while the shaft 22 rotates or vice versa. In either case, the races need protection from the elements and a mechanism to keep any lubricants against the races.

As shown, the inventive flexible bearing seals 10 of the invention have a fixed end 24 which is either held between the housing 18 and the outer race 16 via a housing projection 26 or via a retainer ring 28 snapped into a recess 30 in the housing. The flexible bearing seal 10 includes a free end 34 which has a raised edge 36 which may be raised about 0.015″ to an edge. Once loaded into the bearing assembly, the raised edge 36 provides a constant pre-loading on the flexible bearing seal 10 which ensures constant contact of the raised edge 36 to the inner race 14 thereby providing a seal and creating a grease purging area 40. The seal area is shown by reference numeral 38. The seals 10 flex as they are pushed into position and held by either the housing projection 26 or a retainer ring 28 or other suitable mechanism.

The flexible bearing seal is formed of tough polyurethane which has a memory so it does not take a set and will instead keep constant contact with the inner race 14 as the raised edge 36 slowly wears down. The polyurethane material of the bearing seal 10 wears slowly while putting very little wear on the inner race 14.

The bearing seal 10 of the invention may be a simple one piece design. It is small enough to fit within the same housing as the bearing and requires no new parts since the sealing surface is on the inner race 14 is already hardened and ground. The height of two seals 10 maybe less than about 0.25″ so it is very easy to accommodate the seals 10 in a bearing assembly. The very low drag on the bearings is conducive to high speed bearing applications. The design allows purging of grease through the seal 10 to enable easy lubrication of the seal.

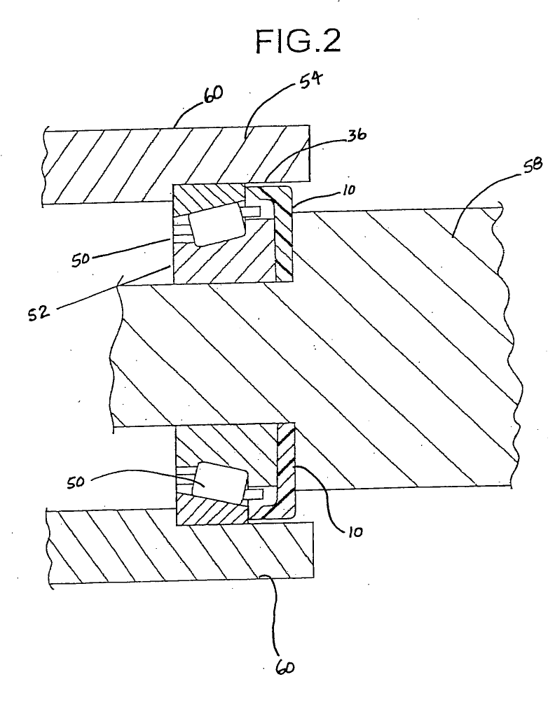

FIG. 2 shows that the inventive flexible bearing seal 10 may be used with a wide variety of bearings, including Timken tapered roller bearings as shown. The seal 10 in FIG. 2 protects the tapered roller bearings 50. The bearings 50 are between the inner and outer races 52, 54 and provide rotational separation between the shaft 58 and housing 60. As shown, the seal 10 in FIG. 2 may require a free end 34 which has a longer raised edge 36 which is needed in this bearing assembly to reach the outer race 54.

This completes the description of the preferred and alternate embodiments of the invention. Those skilled in the art may recognize other equivalents to the specific embodiment described herein which equivalents are intended to be encompassed by the claims attached hereto. The inventive seals of the invention are depicted in connection with two different bearing types to illustrate how they may be used with bearings. Those of ordinary skill in the art can readily appreciate which other bearings may benefit from the seals.

1. (canceled)

2. (canceled)

3. (canceled)

4. (canceled)

5. (canceled)

6. (canceled)

7. In a bearing assembly that include a housing, an inner race defining an outer plane, an outer race and rotating bodies interspersed therebetween, the improvement comprising a seal member that seals the outside plane of the inner race of the bearing assembly.

8. An auxiliary seal for bearings that include a housing, an inner race, an outer race and rotating bodies interspersed therebetween, said auxiliary seal being tensioned to the outer race of the bearing.

9. An auxiliary seal that provides additional or primary sealing for bearings that include a housing, an inner race, an outer race and rotating bodies interspersed therebetween, said auxiliary seal being constructed and arranged to provide a tensioned seal to the inner race of the bearing without providing a seal to a shaft.

10. In a bearing assembly that include a housing, an inner race, an outer race and rotating bodies interspersed therebetween, the improvement comprising an auxiliary seal to the bearing assembly, said auxiliary seal being constructed and arranged of polyurethane in a generally disc shape with an outer circumference to be secured to said bearing housing, said seal constructed and arranged to present an inner raised edge at a central aperture, said raised edge being raised off of a plane the disc shaped seal describes such that when loaded into a bearing housing the raised edge will be pre-loaded onto an inner race of the bearing.
